(19) United States
(12) Patent Application Publication
(10) Pub. No.: US 2005/0005461 A1
(43) Pub. Date: Jan. 13, 2005

(54) Truck alignment system

(76) Inventor: Henry Rohrig, N. Hollywood, CA (US)

Correspondence Address: HENRY ROHRIG, P.O. BOX 2159, TOLUCA LAKE, CA, 91610, US

(21) Appl. No.: 10/607,019

(22) Filed: Jun. 25, 2003

(51) Int. Cl. G01B 5/24

(52) U.S. Cl. 33/203.18

(57) ABSTRACT

There are currently three other types of “Alignment Systems” that align the axles of Class 8 trucks in use today, that I am aware of One system is a totally computerized procedure that attaches to the wheels. The second system uses the side of the tire, and the third system uses the tread of the rear axle as an index point. There has not been any major updates to these three above mentioned in the last 10 years. This invention is the first major “System Change” using the wheel as a reference point, but not using a highly technological computerized system. Using this “Alignment System” it is much more cost effective and user friendly, thus making it more available to the open market.

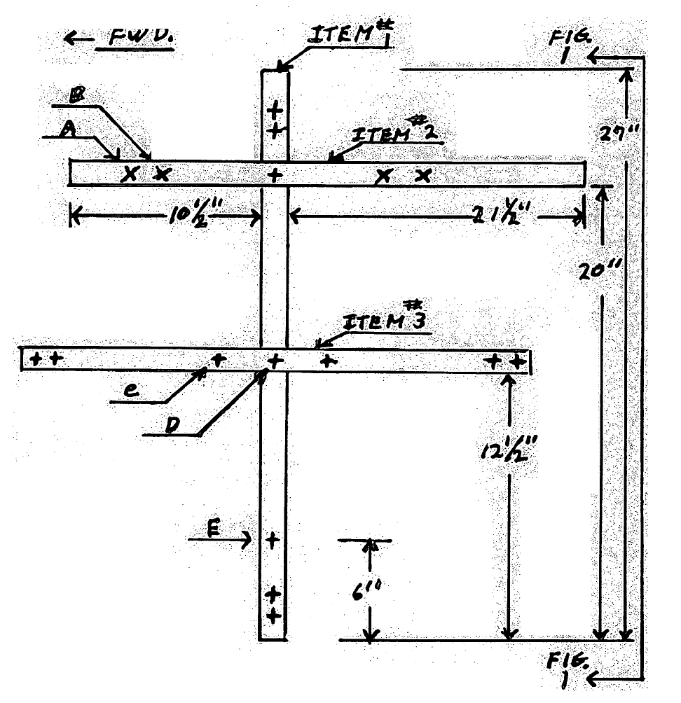

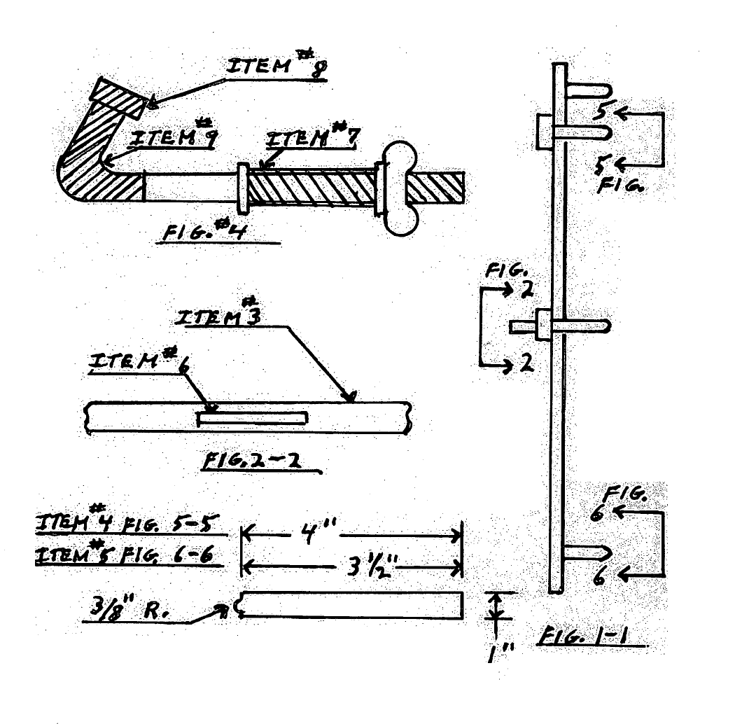

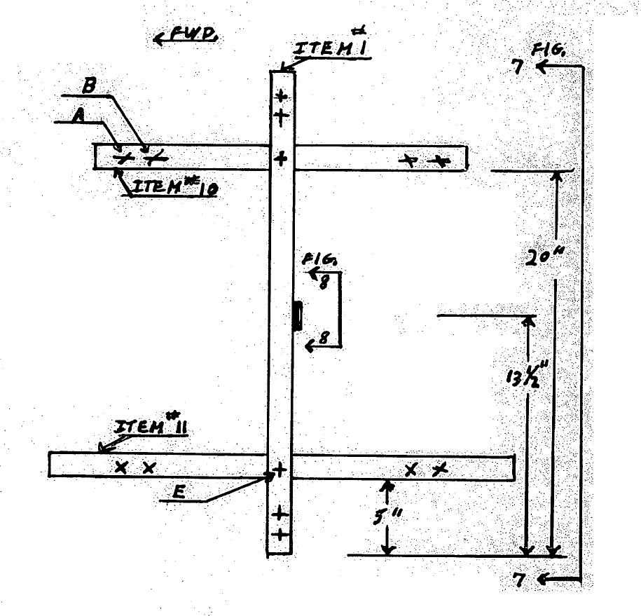

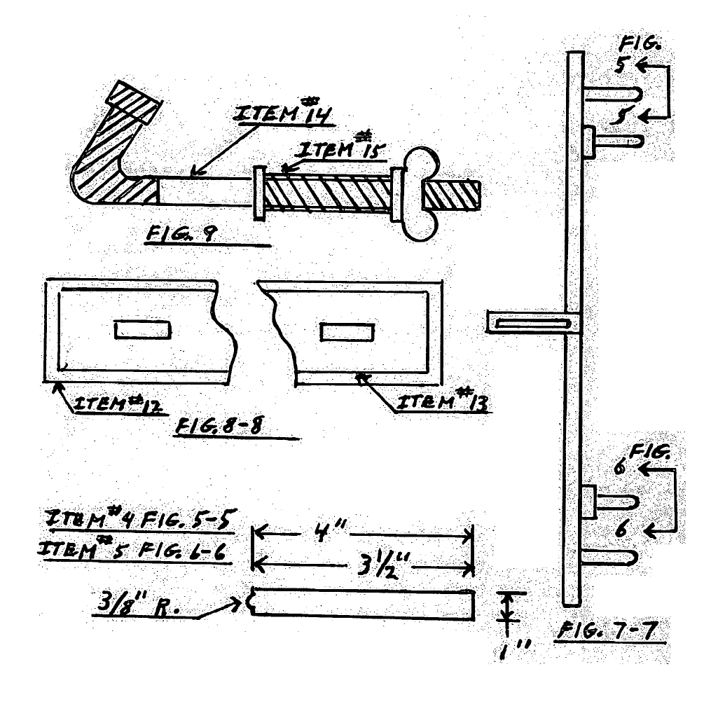

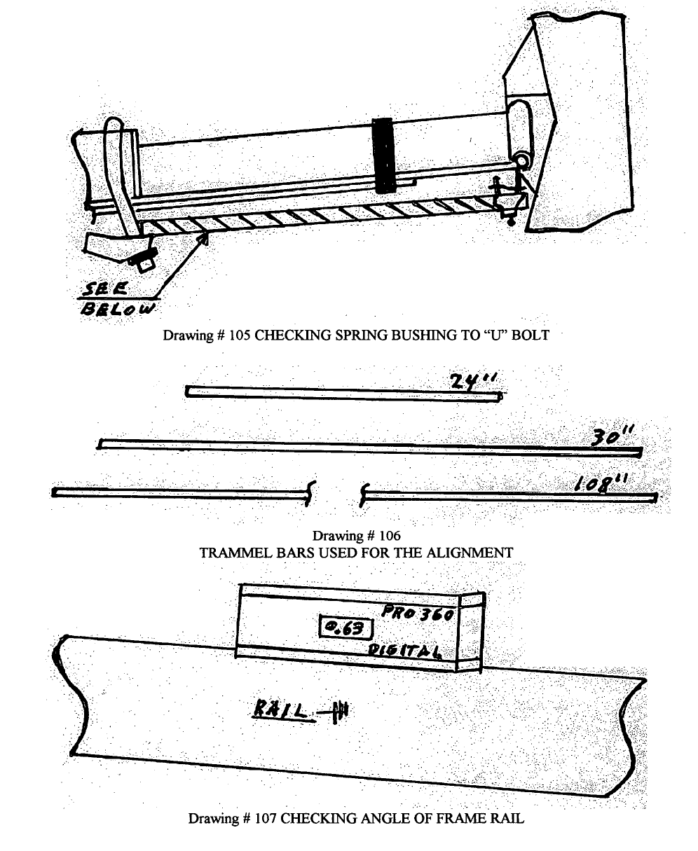

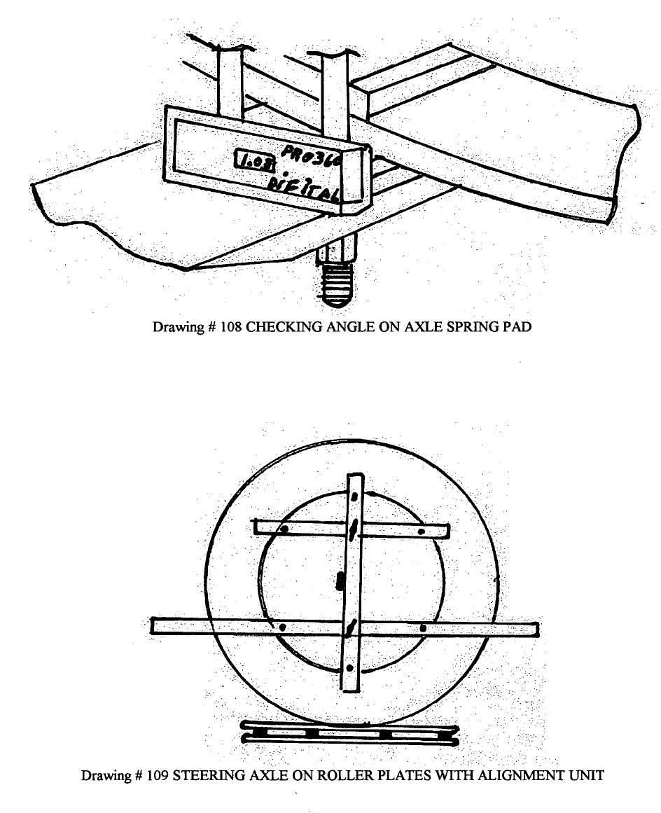

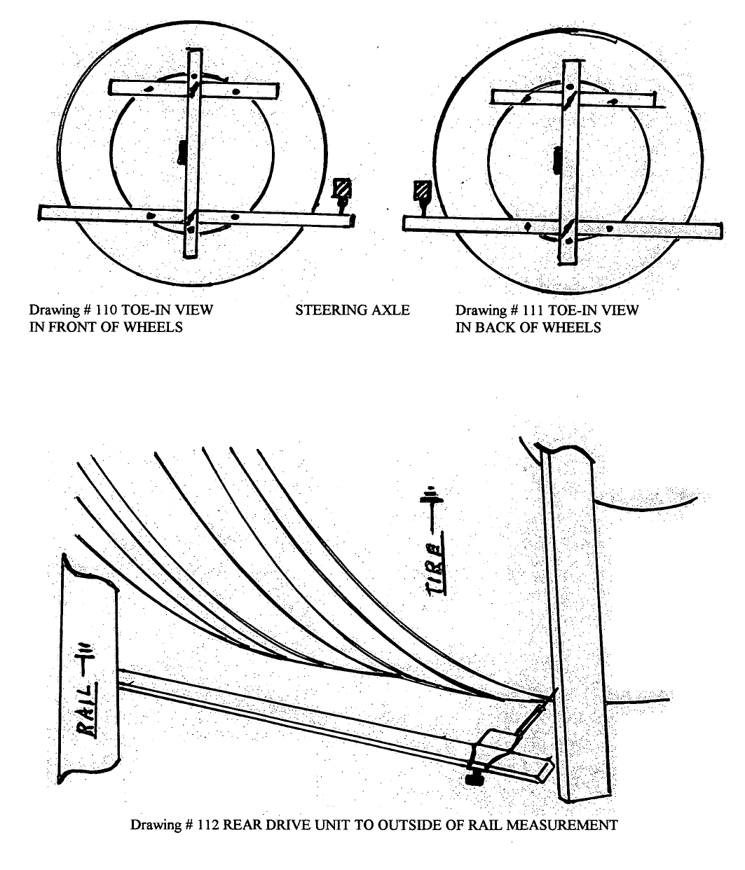

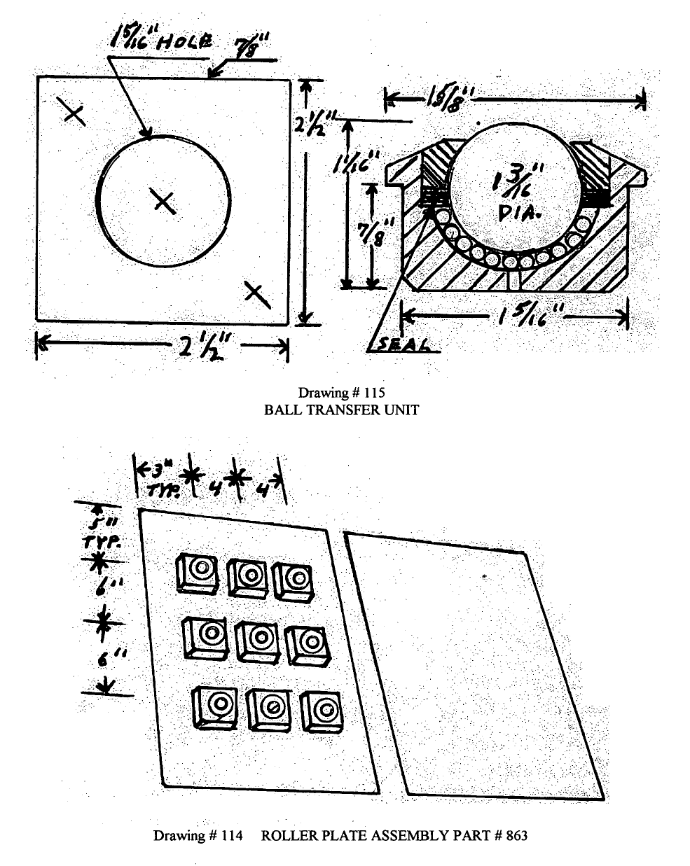

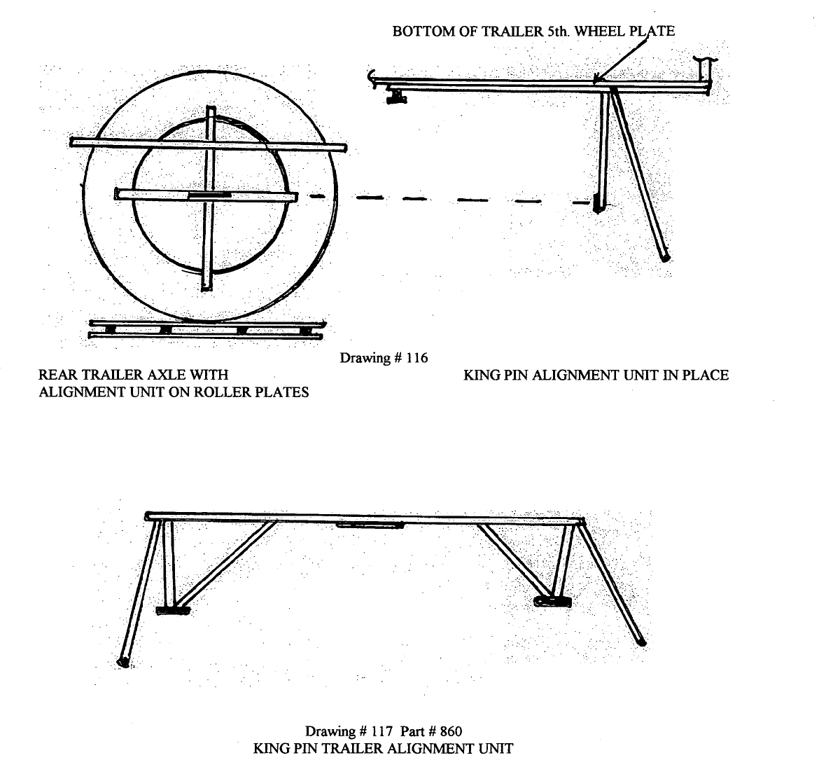

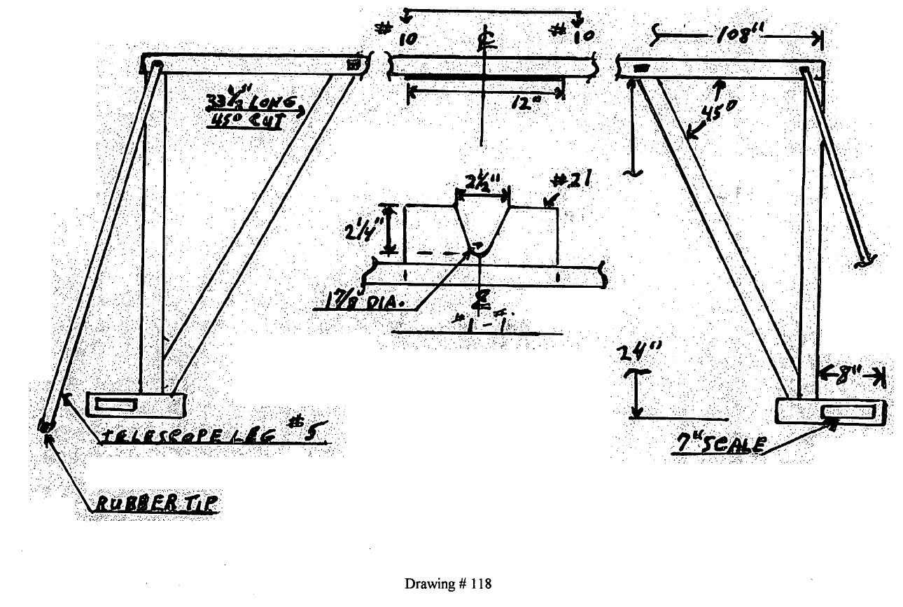

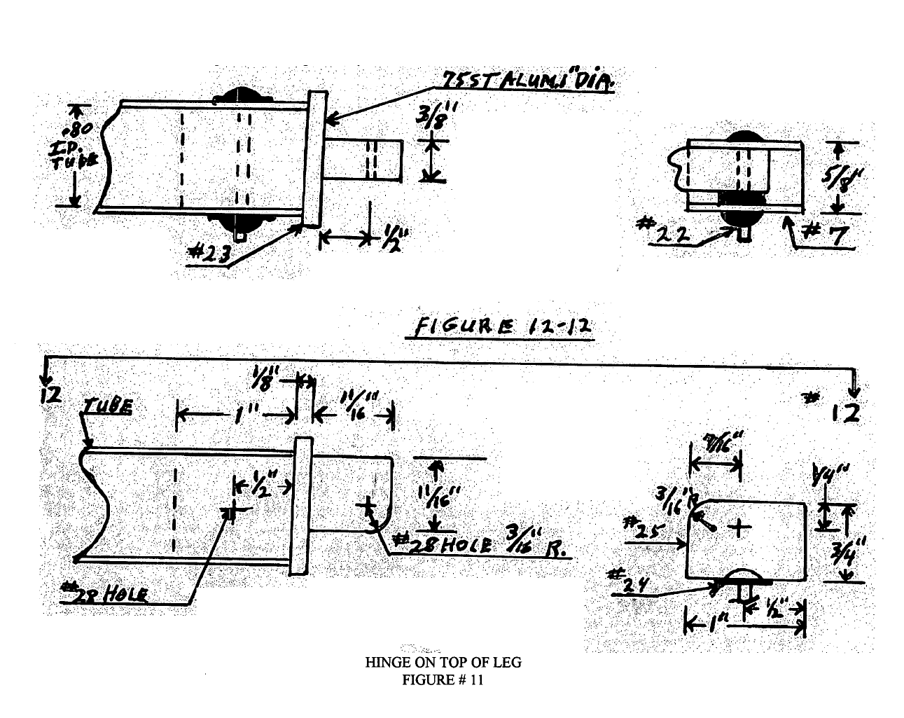

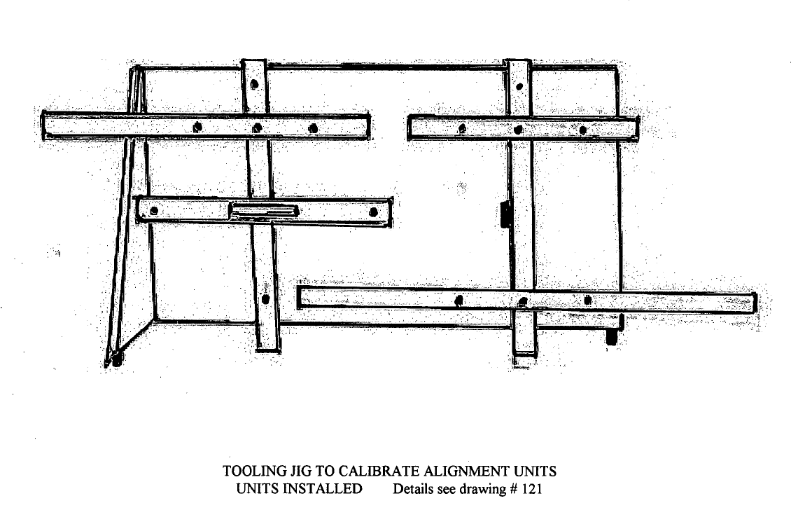

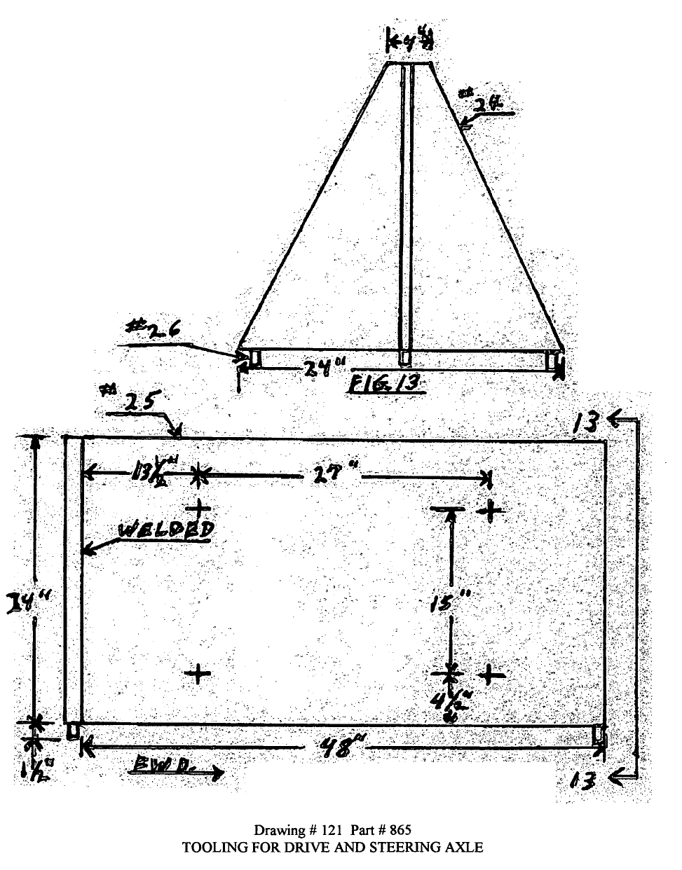

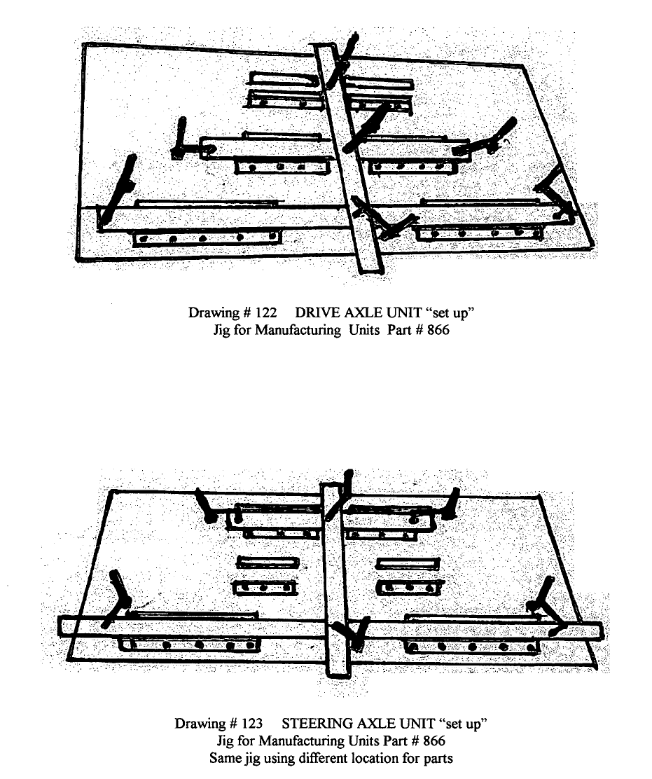

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention is for the alignment of Class 8 Truck—Trailers and Buses. It is standard procedure in the industry to align the steering axle and the drive axles. This should be accomplished periodically depending on the condition of the roads. Most of the roads are in very poor condition, that it is required to do this alignment two times a year. If you drive a truck or bus with it being out of alignment you will wear the tires excessively and it is more difficult to steer and to control—which is a safer factor to consider. Some of the units previously and currently being used—use the tires as the basis of the alignment. Even if tires are inflated equally, the profile will not be exactly the same. Therefore, when you use the tires as a reference point you will not get an accurate reading as using the wheels.

There are some systems that use the wheel, which is 100% better than the other methods of measurement. If you use the tires as a point of reference either from the side wall [which has embossed lettering] or the tread [which has an uneven wear pattern] you will have an inaccurate alignment reading.

### BRIEF SUMMARY OF THE INVENTION

This system uses the wheel as the point of reference. Attaching the tooling to the wheel and projecting the position of the drive wheel onto the steering wheel tooling. This system uses a roller plate to set the wheels on when adjusting so it will move without restriction. This system aligns Class 8 Trucks—buses and also has a unit that is used to align the trailer axles. There are also tooling jigs to calibrate the units.

### BRIEF DESCRIPTION OF THE SEVERAL VIEWS OF THE DRAWING

| | | |
|---|---|---|
| Sheet # 1 | Drawing # 101 | Alignment unit Drive axle part # 856 passenger side/Part # 857 driver side |
| | FIG. # 1 | Depicts a side view of the unit |
| Sheet # 2 | Drawing # 102 | Alignment unit parts brake down |
| | FIG. # 1 | View that depicts FIG. # 2 item # 6 laser level and location. |
| | FIG. # 3 | Deleted. |
| | FIG. # 4 | Item # 7 spring on threaded rod hold down. |
| | FIG. # 4 | Item # 8 rubber tip and Plasti-dip |
| | FIG. # 4 | Item # 7 spring on threaded rod hold down. |
| | FIG. # 5 | Locater pins 4″ long |
| | FIG. # 6 | locater pins 3½″ long. |
| | FIG. # 9 | Threaded rod with washers and wing nuts |
| Sheet # 3 | Drawing # 103 | Alignment unit Steering axle part # 858 passenger side/Part # 859 driver side |
| | FIG. # 7 | Depicts a side view of the unit |
| Sheet # 4 | Drawing # 104 | Alignment unit parts brake down |
| | FIG. # 7 | View that depicts FIG. # 5 and # 6, as same as in drawing # 102 sheet # 2. |
| | FIG. # 8 | Depicts view of Item # 12 as the scale support and Item # 13 depicts 7″ scale. |
| | FIG. # 9 | Depicts Item # 14, spring on Item # 15 threaded rod with washers and wing nuts. |
| Sheet # 5 | Drawing # 105 | Checking spring bushing to U-bolt measurement, with trammel bar ⅜″ × ¾″ × 24″ |
| | | for proper location of axle to direction of travel. |
| | Drawing # 106 | Trammel bars used for the alignment, depicts three sizes of trammel bars ⅜″ × ¾″ × 24″ - |
| | | ⅜″ × ¾″ × 36″ - ⅜″ × ¾″ × 108″ long. |
| | Drawing # 107 | Checking angle of frame rail, with digital level supplied - to get the first angle |
| | | for the alignment. |
| Sheet# 6 | Drawing # 108 | Checking angle on the axle spring pad, with digital level to get the second angle |
| | | to compute with the first angle from drawing # 107 to complete this part of the |
| | | alignment. |
| | Drawing # 109 | Steering axle on roller plates with alignment unit installed. |
| Sheet # 7 | Drawing # 110 | Toe-in view in front of wheel, with alignment unit installed using the ⅜″ × ¾″ × 108″ |
| | | trammel bar in front of wheel on the steering axle. |
| | Drawing # 111 | Toe-in view in back of wheel, with alignment unit installed using the same |
| | | trammel bar and setting in back of wheel, [that point is preset by 1/16″] for |
| | | standard toe-in adjustments. |
| | Drawing # 112 | Rear drive unit to out side rail measurement, checking rail to be sure it is |
| | | centered on the axle. |
| | Drawing # 113 | DELEATED |
| Sheet # 8 | Drawing # 115 | Ball transfer unit, installed on the roller plates to allow the axle to move |
| | | without restriction. |
| | Drawing # 114 | Roller plate assembly part # 863, supplied to place wheels on during alignment |
| | | so the axle will move without restriction. |
| Sheet # 9 | Drawing # 116 | Rear trailer axle with alignment unit, installed on wheel to project laser light |
| | | unto king pin unit for alignment - wheel is also placed on roller plates so they |
| | | will move without restriction. |
| | Drawing # 117 | King pin trailer alignment unit, depicts trailer unit complete and standing as if |
| | | it was installed. |
| Sheet # 10 | Drawing # 118 | King pin trailer alignment unit parts brake down, FIG. # 10 depicts item # 21 |
| | | that locates unit to king pin, the other parts are self explanatory, |
| Sheet # 11 | Drawing # 119 | King pin trailer alignment unit parts brake down, depicts hinge on top of leg, |
| | FIG. # 11 | Plan view depicts the two parts of the hinge. |
| | FIG. # 12 | View is rotated 90 degree to depict the other side for manufacturing. |
| Sheet # 12 | Drawing # 120 | Tooling jig to calibrate alignment unit part # 865. Units are installed on the jig |
| | | in the same position as on a truck or a bus and you project the laser light onto |
| | | the scale of the steering axle tooling for calibration. |
| Sheet # 13 | Drawing # 121 | Tooling jig to calibrate alignment unit parts brake down, and how it is |
| | | manufacted |
| | FIG. # 13 | Depicts the view rotated 90 degree to show the other |
| | | side for manufacturing. |
| Sheet # 14 | Drawing # 122 | Jig to manufacture alignment units for drive axle, they all use one jig with |
| | | different hold down angles and clamps. The locater pin holes are drilled in this |
| | | jig to make all parts more accurate. |
| | Drawing # 123 | Jig to manufacture alignment units for steering axle, same jig only using the |
| | | other set of angles and hold clamps. |
| -END- | | |

### DETAILED DESCRIPTION OF THE INVENTION

When you find any of the following items out of manufactures specifications—due to ware—poor workmanship previously—broken or damaged in any way these items must be corrected.

Starting the alignment with the vehicle on a level surface, then raise the hood [to have a full visual view of the front, back and top of the tire and wheels]. At this point use only the adjustable trammel point with the ⅜″×¾″×24″bar—placing one end of the trammel bar on the “U” bolt above the axle pad and adjusting the trammel point so it would be touching the spring bushing at the bracket. You then go to the other side of the truck—and do the same thing at the same point. You are checking to establish that the axle reference is true to the direction of the truck. If this is not correct you must correct before continuing, see drawing # 105 page # 5. Using the level on the top of the rail over the spring and noted the degree drawing # 107 page# 5, then place the level on the top surface of the axle spring pad, see drawing # 108 page# 6. Then compare the two angles and see if the degree angle is within the manufactures specifications for the caster setting for that axle. Most of the caster settings on the class 8 trucks will be between 3 and 4 degree positive angle, if correct continual on. At this point jack the steering axle and rotate the wheel checking the bearings for there condition and tightness. Now you check the wheel movement top to bottom making sure the king pins are not worn. Now you move the wheel from side to side checking to see if you have any movement in the tie rod ends or drag link. Check the spring bushing with a steel pry bar to make sure they are not worn excessively. You do the same thing on the other side. When everything checks out you lower the wheels onto the roller plates, see drawing # 109 page # 6 also drawing # 114 page 8.The roller plates allow the wheels and axle to move freely with the weight of the truck. Then take the steering axle alignment units part # 858 and part # 859 and attach them to both wheels, see drawing # 109 page # 6.The bottom and lower front pins are fixed to locate unit—use the two threaded rods to hold the unit to the wheel. Then rotate the other four pins to rest in wheel radius and tighten allen bolts. Then use the toe-in trammel point bar ⅜″×¾″×108″checking the front dimension using the black index point on the top edge of the bottom bar, drawing # 110 page # 7. Then move the trammel bar to the back of the wheel and using the red index point that is perset for 1/16″, see drawing # 111 page # 7,that setting will give you the proper toe-in when adjusted. Rejack steering axle and remove roller plates.

There are two units one for each side of the truck they are made using ½″×2″6061 aluminum bar and welded, together, the alignment pins made from 75 ST aluminum round bar. Machined one end to ¾″ with ⅜″ radius and ⅛″ shoulder that rest in the wheel radius to locate unit. The other end milled off flat and the two fixed pins have steel insert part # 651-04 threaded in the center and the other four pins have the steel insert located 3/16″ off center so they are adjustable, they are attached with ¼″ allen bolts. There is a chain that keeps them, from getting lost or damage. There are two sets of holes for the pins one is for 22.5″ size marked B on drawing, inner circle 11 1/16″ radius, the other for the 24.5″ size marked A on drawing, outer circle 12 1/16″ radius All dimension taken from location D at center of unit. For more information see material list below and the drawing # 101 sheet # 1.

C—on drawing 2 places 5 ½″ apart # 21 hole use a 10-32 tap and install 1″ socket set screws part # 101287 w/locknut. Adjust and tighten to secure level.

D—on drawing ¼″ hole using ¼″-20×2″ socket set screws into center hole in level using nylon locknut.

E—on drawing 1″ hole 6″ from top and bottom on center upright, ⅜″ threaded rod to hold unit onto wheel.

| Item | Material list for one side, it requires two units one opposite. | | |
|---|---|---|---|
| # 1 | 1 pc. | center upright ½″ × 2″ × 27″ | 6061 aluminum bar stock |
| # 2 | 1 pc. | top cross member ½″ × 2″ × 34″ | 6061 aluminum stock |
| # 3 | 1 pc. | center cross member ½″ × 2″ × 27″ | 6061 aluminum stock |
| # 5 | 2 pc. | top and bottom locater pins 1″ × 3½″ | 75 ST aluminum stock FIG. # 1 - # 1 |
| # 4 | 4 pc. | locater pins 1″ × 4″ | 75 ST aluminum round stock FIG. # 1 - # 1 |
| # 6 | 1 pc. | laser level part # 46735 FIG. # 2 - # 2 | |
| # 9 | 2 pc. | ⅜″ threaded rod 19″ long with 1¾″ bend at 60 degree with 2 fender | |
| | | washers springs & wing nut FIG. # 4 | |
| # 7 | 2 pc. | ⅜″ ID. × 3″ springs FIG. # 4 | |
| # 11 | 7 pc. | ¼″ × 1¼″ allen bolt - not shown | |
| # 16 | 6 pc. | ¼″ × 6″ chain w/drive pins # 6 × ½″ - not shown | |
| # 8 | 2 pc. | ⅜″ ID. rubber hose ½″ long and cover with plasti-dip red FIG. # 4 | |

There are two units one for each side of the truck they are made using ½″×2″ 6061 aluminum bar stock and welded together, the alignment pins made from 75 ST aluminum 1″round bar stock. Machined one end to ¾″ with ⅜″ radius and ⅛″ shoulder that rest in the wheel radius to locate unit. The other end milled off flat and the two fixed pins has steel insert part # 651-04 threaded in the center for bottom and lower front pin to locate unit, the other four pins has the steel insert located 3/16″ off center so it is adjustable, all the pins are attached with ¼″ allen bolts. There is a chain that keeps them from getting lost or damage. There are two sets of holes for the pins, one is for 22.5″ size wheel “B” on drawing inter circle 11 1/16″ radius marked red index on tooling, the other 24.5″ size wheel “A” on the drawing outer circle 12 1/16″ radius marked black index on tooling.

“E” on drawing depict a 1″ hole 6″ from top and bottom of the upright, for the ⅜″ threaded rods to hold unit onto wheel.

FIGURE # 7 Depicts side view of unit

FIGURE # 8-8 The plate material ¼″×1 ½×7 ¼ 6061 aluminum bar stock, figure depicts steering axle driver side, other side opposite. Plate to hold scale, drill # 36 holes & tap with 6-32. Next weld them on with the end even with the inside of center upright. Install using 6-32×¾ socket head cap screw part # 011061 with flat washers & nylon locknuts. This is for the adjustment on the alignment units when in the jigs. The ⅛″ wide×⅜″ long grove line up with the screws and the 1″ mark begin there and the nos. go out to 7″. Scale on the other side is opposite. For more information see material list next and the drawing # 104 sheet # 4.

| Item | Material list for one side, it requires two units one opposite. | | |
|---|---|---|---|
| # 1 | 1 pc. | center upright ½″ × 2″ × 27″ | 6061 aluminum bar stock |
| # 10 | 1 pc. | top cross member ½″ × 2″ × 22″ | 6061 aluminum bar stock |
| # 11 | 1 pc. | bottom cross member ½″ × 2″ × 46″ | 6061 aluminum bar stock |
| # 4 | 2 pc. | top and bottom locate pins 1″ × 4″ FIG. #5 #5 | 75 ST round stock |
| # 5 | 4 pc. | locate pins 1″ × 3½″ FIG. # 6 # 6 | 75 ST round stock |
| # 12 | 1 pc. | scale support ¼″ × 1½″ × 7¼″ | 6061 aluminum bar stock |
| # 13 | 1 pc. | 7″ scale FIG. # 8 - # 8 Item # 13 | |
| # 14 | 2 pc. | ⅜″ threaded rod 11½″ long with | |
| | | 1½″ bend 60° with 2 fender washers-and | |
| | | wing-nut ⅜ rubber hose and covered with plasti- | |
| | | dip red FIG. # 9 | |
| # 15 | 2 pc. | ⅜″ ID × 3″ springs | |
| # 16 | 6 pc. | ¼″ × 6″ chain with drive | |
| | | pins #6 × ½″ - not shown | |
| # 11 | 6 pc. | ¼″ × 1¼″ allen bolts - not shown | |

Drive Axle—jack the rear drive axle—rotating the wheel and checking bearings for condition and tightness. You will also check the brake drums making sure they are not rubbing or the brakes are not out of adjustment. Now check if there is wheel movement top to bottom or side to side. If so you must replace bearings or recalibrate. When everything checks out you lower the wheels onto the roller plates. Next you install the drive axle alignment units and attach them to both wheels Drawing # 116 Page # 10 shown on trailer axle same as on drive axle. The bottom and lower front pins are fixed to locate unit use the two threaded rods to hold the unit to the wheel, then rotate the other four pins to rest in wheel radius and tighten allen bolts in both units. Next using the ⅜″×¾″×36″ trammel point bar and the adjustable trammel only—place the one end of the bar to the out side of the rail and the trammel point on the index point on top of the top member of the tooling rear section locking it and checking the same place on the other side Drawing # 112 page # 7.If this is not the same you must add or remove shims from the transverse rod to frame racket to center axle on rails. Next turn laser light on both sides and light will be projected on the scale in the center of the steering axle tooling, if it is not the same number on both scales the drive axle will be adjusted to align up correctly. After this rejack and remove roller plates. If you have two drive axles then proceed to forward drive axle and complete in same manner. This unit made with 1/16″×1 ½″×1 ½″4130 steel tubing and ⅛″ steel plate see material list; Bottom section supporting a 7″ scale with 1/16″ graduation used for the alignment. These two scales have a index point at the 3″ mark that is used to calibrate the unit. To calibrate use the trammel point and bar ⅜″×¾″×108″, place one end on the 3″ mark the other on the index point at the red dot, top center of unit, then swing to other side and set on scale 3″ mark and adjust scale if required. This is calibrated with the king pin, it has two telescope legs that swing down and touch the ground. This holds the unit in place with the king pin, this plate is # 21 on the drawing # 118. Drawing # 119, depict the hinge for the top of the telescope leg on each side. Item # 24 figure #11 depict a 10/32×¾″ screw and ⅛″ rubber washer w/locknut. Item # 25 figure # 11 depict a “U” channel 1/16″×¾″×⅝″×¾″ long, 75 ST aluminum as part of the hinge, with 6/32×1″screw and ⅛″ rubber washer w/locknut. In both places the rubber washer works to stabilize the hinge movement. Some shops use the outside of trailer which can be incorrect if it is damage. The only true part is the king pin.

To align the trailer you would use the Drive Axle Alignment tooling part # 856-857 drawing # 101 sheet #1. Jack the rear axle rotating the wheel and checking bearing for condition and tightness. You will also check the brake drums making sure they are not rubbing or the brakes are not out of adjustment. Now check if there is wheel movement top- to bottom or side to side, if so you must replace the bearings or recalibrate then. When everything checks out you lower the wheels onto the roller plates, see drawing # 116 sheet # 9.Next you install the same tooling used for the drive axle alignment part # 856-857 attach them to both wheels, see drawing # 116 sheet # 9. Attach them to both wheels, the bottom and lower front pins are fixed to locate unit, use the two threaded rods to hold the units to the wheels, then rotate the other four pins to rest in wheel radius and tighten allen bolts in both units. Next turn laser light on both sides and light will be projected on the scales located on the king pin tooling, see drawing # 116 sheet # 9. If it is not the same number on both sides the axle will have to be adjusted to align up correctly. After this rejack and remove roller plates. If you have two axles then proceed to forward axle and repeat the same method again.

Material list;

| | | |
|---|---|---|
| # 16 | 1 pc. | top frame 1½″ × 1½″ × 108″ 4130 steel |
| # 17 | 2 pc. | angle brace 1½″ × 1½″ × 33⅞″ cut on 45 degree angle |
| # 18 | 2 pc. | side frame 1½″ × 1½″ × 24″ |
| # 19 | 2 pc. | plate for scale ⅛″ × 1½″ × 12″ 4130 steel plate |
| # 20 | 2 pc. | telescope leg # 9406 aluminum tube 1″ × 48″ to 60″ |
| # 21 | 1 pc. | alignment plate king pin ⅛″ × 6″ × 12″ 4130 steel plate |
| # 25 | 2 pc. | “U” channel for the hinge 1/16″ × ¾″ × ⅝″ × ¾″ × 1″ long 75 ST aluminum |
| # 23 | 2 pc. | 1″ aluminum 75 ST machined as per FIG. # 11 # 11 and # 12 # 12 drawing # 119 sheet # 11 |
| # 22 | 2 pc. | ⅛″ Rubber washer with 6-32 × 1″ phillips head screw with lock nut |
| # 24 | 2 pc. | ⅛″ Rubber washer with 10-32 × ¾″ phillips head screw |

Roller plates assembly part # 863 are used under all the wheels when making any adjustments during the alignment. The bottom plate is ¼″×14″×22″ steel plate with 9 blacks of 75 ST aluminum, ⅞″×2 ½″×2 ½″ with a 1 3/16″ diameter hole in the center for the ball transfer unit # 30 MPC to be pressed into the block and it is attached to the bottom plate with # 10×32×1 ⅜″ flush head screw with locknuts. There are three rows, 3″ from each side and one row in the center. They are 5″ from the top and bottom with one row in the center. Each roller load capacity is 770 lbs. total of 6,930 lbs. for each assembly. The top plate is ⅜″×14″×22″ and it lays on the rollers so it will move without restriction. Drawing # 114 sheet # 8, drawing # 115 sheet # 8 depict the unit.

Tooling jig that calibrates the alignment units part # 865 Shown on drawing # 120 sheet # 12 with the alignment units installed using the threaded rods to hold in place. Turn laser lights on both sides, the light will be projected onto the scales on the steering axle tooling. If the light does not align to the same number on each side, adjust the scale to align to the proper number. Drawing # 121 sheet # 13 depicts how it is manufactured.

| Item | Material list: | | |
|---|---|---|---|
| # 24 | 1 pc. | ⅜″ × 24″ × 24″ | 6061 aluminum - cutting the piece on both sides going from bottom |
| | | | corner to the top with a 4″ flat in the center, cut to this point. |
| # 25 | 1 pc. | ⅜″ × 24″ × 48″ | 6061 aluminum - this is for one jig, drill 4 holes ¾″ diameter as |
| | | | depicted on the drawing # 121 sheet # 13. |
| # 26 | 3 pc. | ⅝″ × 1″ | 6061 aluminum - this is for three legs |

The jig part # 866 used to manufacture the alignment units for the drive axle part # 856/part # 857 see drawing # 122 sheet # 14. Steering axle part # 858/# 859 see drawing # 123 sheet # 14. The one jig is used for the four units. Material is ½″×24″×48″ steel plate, 3/32″×1 ½″×1 ½″ steel angle bolted on, and hold down clamps # DE-SAT-CO model # 207-UL with ¼″×1 ¼″ bolts with locknuts. After placing then in the jig, weld together and drill holes for the location pin, when completed remove form jig and mill surface where locator pins attach and where the laser light attach on the drive axle units.

1. Using the adjustable trammer point with the 24″ rod to measure the proper distance from the spring bushing and the front of the “U” bolt instead of a tape measure, which is not as accuracy. All of the alignment actually starts here, for if the steering axle is not align correctly the complete job will not be correct.

2. The use of tooling and its attachment to the wheels using locator pins and threaded hold down rods, in this manor you have a better attachment and one that is more accurate.

3. The place the scale is attached to the steering axle tooling, the laser light is projected onto this accurately from the drive axle.

4. The attachment of the laser beam light on the tooling for the drive axle, and is attached to the wheel using locator pins and threaded hold down rods, instead of resting on the tire in some manner.

5. The tooling index point located on the top edge of the lower cross bar in front and back of the wheel, the rear point is preset by 1/16″ in from center so the dimension for the toe-in would be correct when the same trammel point adjustment is used in the rear index point, this eliminates the possibility of an error.

6. Using the adjustable trammel point with the 36″ rod, placing one end of the bar against the out side of the rail and the trammel point on the top edge of the top cross bar back of the wheel, set and then check the other side, this must be the same.

7. The roller plates which is used under all of the wheels when making any adjustments on the axle, so it will move without restriction.

8. The drive axle unit of the system is also used for alignment on single or double axle trailers, if it is not aligned properly it will force the truck to one side or the other, that is very important for safety and cost.

9. The Jig used to calibrate the tooling, you can not design tooling and not design some way to calibrate the units, for if it is not correct the finish job also will not be correct. All of this is very important for safety and the cost of operation.

10. Tooling Jigs to manufacture steering units left and right side—drive units left and right side, are all made with this one jig and drilled to locate the pins for the attachment of the units to the wheels. It is made of ½″ steel plate with steel angles and clamps bolted on to hold parts in place for welding.

11 The Alignment units are made with ½×2″ 6061 aluminum bar stock and some are made using 4130 steel tubing, 3/16″×½2″ rectangular stock, all of the dimensions are the same, some mechanics like steel units.
